(19) United States
(12) Patent Application Publication
(10) Pub. No.: US 2004/0000235 A1
(43) Pub. Date: Jan. 1, 2004

(54) Dry separation method and a separation apparatus

(75) Inventors: Jun Oshitani, Okayama City (JP); Zennosuke Tanaka, Okayama City (JP)

Correspondence Address: OLIFF & BERRIDGE, PLC, P.O. BOX 19928, ALEXANDRIA, VA, 22320, US

(73) Assignee: OKAYAMA UNIVERSITY, Okayama City (JP)

(21) Appl. No.: 10/414,208

(22) Filed: Apr. 16, 2003

(30) Foreign Application Priority Data
Apr. 30, 2002 (JP) 2002-128,007

(51) Int. Cl. B01D 46/32

(52) U.S. Cl. 95/275; 55/474

(57) ABSTRACT

In the dry separation method, an object to be separated is charged into a gas-solid fluidized bed of powder to conduct continuous separation of components utilizing a bulk density of the gas-solid fluidized bed.

### BACKGROUND OF THE INVENTION

1. Field of the Invention

This invention relates to a dry separation method capable of conducting gravity separation of an object to be separated into various components without liquid.

2. Description of Related Art

In industrial products, mineral resources, industrial wastes and so on, each of which being made from various raw materials, are included various different components. Therefore, it is necessary to separate these components from each other for conducting the purification of the mineral resources and the recycle of the resources.

Up to now, a wet separation method and a dry separation method are mainly known as a separation method.

In the dry separation method, however, there are still problems that an apparatus cost is high and an efficiency is low and the like. In the wet separation method, there are problems that an environmental pollution is caused by treating a waste liquid, and this method can not be utilized in areas being less in water resource and a dry step is required after the treatment of the waste liquid or the separation.

Also, it is often the case that the object to be separated contains impurities in addition to objective components. However, there is not known a method of continuously recovering the objective components while removing the impurities up to now.

### SUMMARY OF THE INVENTION

Therefore, the invention is to provide a dry separation method and an apparatus therefor capable of continuously separating the object to be separated into components at a low cost, and being good to environment.

The inventors noted that a gas-solid fluidized bed fluidizing powder has a nature similar to a liquid in the density, viscosity and the like. Particularly, the inventors have examined behaviors of material bodies having various densities under a fluidization condition, and as a result, the invention has been accomplished.

According to a first aspect of the invention, there is the provision of a dry separation method which comprises charging an object to be separated into a gas-solid fluidized bed fluidizing powder and continuously separating the object to be separated into components through the utilization of a bulk density of the gas-solid fluidized bed.

In a preferable embodiment of the first aspect of the invention, the continuous separation is carried out by changing the bulk density.

In another preferable embodiment of the first aspect of the invention, the fluidization of powder is carried out by blowing air into a lower part of the gas-solid fluidized bed.

In the other preferable embodiment of the first aspect of the invention, the air blowing is carried out under a condition that an air permeability is not more than 5.0(cm³/s)/cm².

In a further preferable embodiment of the first aspect of the invention, the air blowing is carried out at a ratio u₀/u_{mf} of 1-4 wherein u₀ is a superficial velocity and u_{mf} is a minimum fluidization velocity of the powder.

In a still preferable embodiment of the first aspect of the invention, when plural powders are fluidized, the air blowing is carried out under a value of the ratio u₀/u_{mf} so as to uniformly mix the plural powders.

In a yet further preferable embodiment of the first aspect of the invention, the powder is at least one selected from the group consisting of unibeads®, glass beads, zirconsands, polystyrene particles, steel shots and powders having a density nearly equal thereto.

In another preferable embodiment of the first aspect of the invention, the object to be separated is a mineral ore and contains an impurity(s).

In the other preferable embodiment of the first aspect of the invention, the mineral ore is silicastone and pyrophyllite.

In a further preferable embodiment of the first aspect of the invention, the powder has an average particle diameter of 100-500 μm.

According to a second aspect of the invention, there is the provision of a dry separation apparatus comprising a separation tank including therein a gas-solid fluidized bed fluidizing powder and provided on its bottom face with a porous dispersing plate(s), and plural transport means, at least a part of which being got into the gas-solid fluidized bed.

In a preferable embodiment of the second aspect of the invention, at least one of the plural transport means transports sediments sunk in the gas-solid fluidized bed and discharges them from the separation bath to an outside thereof.

In another preferable embodiment of the second aspect of the invention, at least one of the plural transport means transports floats levitated in the gas-solid fluidized bed and discharges them from the separation bath to an outside thereof.

In the other preferable embodiment of the second aspect of the invention, the transport means is a rotatable collecting means set in an inclined position.

### BRIEF DESCRIPTION OF THE DRAWINGS

The invention will be described with reference to the accompanying drawings, wherein:

FIG. 1 is a schematic view showing an embodiment of the apparatus for separating an object to be separated according to the invention;

FIG. 2 is a schematic view showing an embodiment for recovering components from an object to be separated according to the invention;

FIG. 3 is a schematic view showing another embodiment for recovering components from an object to be separated according to the invention;

FIG. 4 shows a schematic view illustrating an embodiment of the separation system according to the invention;

FIG. 5 is a graph showing a density distribution of a material body at various V_{s.s.} values;

FIG. 6 is a graph showing float-sink states of silicastone and pyrophyllite by changing an air permeability;

FIG. 7 is a graph showing a height of each object to be separated in a fluidized bed;

FIG. 8 is a graph showing a height of each object to be separated in a fluidized bed; and

FIG. 9 is a graph showing heights of silicastone and pyrophyllite in a fluidized bed.

### DETAILED DESCRIPTION OF THE INVENTION

The principle of the invention is explained as follows. That is to say, the object to be separated is mainly separated according to its density by fluidizing powder to utilize a powder fluidized medium similar to that in a gravity selection of a liquid system, that is, a gas-solid fluidized bed. The term “gas-solid fluidized bed” used herein means that it has a nature similar to that of liquid by fluidizing powder.

Firstly, a concept of the separation through the gas-solid fluidized bed is described as follows. When a gas is fed to the powder to conduct float fluidization, the fluidized bed of the powder shows a behavior similar to a liquid. Therefore, a bulk density ρfb of the fluidized bed is shown by the following equation:

ρfb=WpVf=(1−εf)ρp

wherein Wp is a powder weigh of a fluidized medium, Vf is a volume thereof in the fluidization, εf is a void fraction in the fluidization, and ρP is a powder density of the fluidized medium.

When the object to be separated having a density ρs is included in the fluidized bed having the above bulk density ρfb, a component to be separated having a ρs<ρfb levitates to an upper part of the fluidized bed, and a component to be separated having a ρs>ρfb sinks to a lower part of the fluidized bed. And also, a component to be separated having a ρs=ρfb floats in a middle part of the fluidized bed. By utilizing this fact is carried out the gravity selection of the object to be separated.

In this way, it is possible to separate each of the components in the object to be separated. Therefore, it is possible to easily recycle each component separated.

In the invention, the object to be separated is not particularly limited based on the above separation principle. As the object to be separated, mention may be made of various mineral resources, industrial products, shredder dusts and so on. As the mineral ore are mentioned ores such as silicaston, pyrophyllite and the like; and raw coal mined from coal mines and so on. As the shredder dust, mention may be made of shredder dusts derived from household dusts, automobiles, home electric appliances and the like. As mentioned above, any objects to be separated may be used, but if the object to be separated is contaminated, it is preferable to conduct the separation after the washing. This is due to the fact that since components to be separated are mainly separated through the difference of their specific gravities according to the separation method of the invention, if the object to be separated is contaminated, there is a fear of causing the change of the specific gravity.

Also, it is necessary to separate the object to be separated by drying after the washing. In the case of separating the object to be separated for recycling use, it is preferable to use powder obtained by pulverizing the object to be separated through a shredder or the like from a viewpoint of a size of an apparatus or the like after the drying for the separation.

In the invention, the continuous separation every component can be carried out, for example, by changing the bulk density of the gas-solid fluidized bed, or by arranging two or more gas-solid fluidized beds in series, or the like.

The change of the bulk density in the gas-solid fluidized bed can be carried out by changing a value of a ratio u₀/u_{mf} as described later, or by changing powder used in the gas-solid fluidized bed, or by changing a particle size of the powder, or by changing a mixing ratio of mixed powders.

Since the change of the bulk density is also dependent on a sort of the object to be separated, if a value of the ratio u₀/u_{mf} is increased, the bulk density does not always decrease. On the other hand, when the density of the powder used in the gas-solid fluidized bed is high, the bulk density of the gas-solid fluidized bed generally tends to rise. Also, as the particle size of the powder is large, the bulk density tends to become large. Therefore, considering these facts, the continuous separation of the components is made possible by changing the bulk density.

In a preferable embodiment of the dry separation method according to the invention, the fluidization of the powder is carried out by blowing air to a lower part of the gas-solid fluidized bed, whereby the number of separable components can be increased. However, the invention is not intended to restrict the air blowing to the lower part of the gas-solid fluidized bed. For example, it is possible to separate a component having a relatively low specific gravity even by blowing air from a lateral direction. If a component having a low specific gravity is clearly existent, it is possible to separate this component in a high efficiency by the air blowing in the lateral direction because a flying distance of the component in the lateral direction is large. Therefore, the component having a low specific gravity is firstly removed by the air blowing in the lateral direction, and thereafter each remaining component in the object to be separated may be removed.

If a component having a low specific gravity is existent as an impurity in the object to be separated in addition to objective components, such an impurity can be removed by the same procedure as mentioned above.

In the invention, the air blowing is carried out under a condition that an air permeability is not more than 5.0 (cm³/s)/cm² because the stabilization of float-sink can be attained by controlling the air permeability. The air permeability depends on the object to be separated, but is not particularly limited. The air permeability is not more than 5.0 (cm³/s)/cm², preferably not more than 3.0 (cm³/s)/cm², and more preferably not more than 1.0 (cm³/s)/cm².

In the invention, u₀/u_{mf} is one parameter for controlling the separation, in which u₀ is a superficial velocity and u_{mf} is a minimum fluidization velocity of the powder. Because two components having a very close density difference therebetween can be easily removed by adjusting the superficial velocity, or the separation of components having a large density difference therebetween can be attained in a short time by increasing the superficial velocity.

In general, when the superficial velocity is set to be not less than the minimum fluidization velocity but near to the minimum fluidization velocity, the density distribution of components in the object to be separated floating in the gas-solid fluidized bed become narrower, but as the superficial velocity is more increased, the density distribution of components in the object to be separated floating in the gas-solid fluidized bed is widened.

Therefore, the invention has an advantages that two components (two materials) having a small density difference therebetween, which have hardly been separated in the conventional technique, can be separated. In order to delicately control the superficial velocity, it is mentioned to use powder having a low air permeability in the lower part of the gas-solid fluidized bed dispersing air therein, and the like.

In case of roughly separating the components, it is possible to basically divide the components into 3 types of a levitating component, a middle floating component and a sinking component. In the end, however, the separation of the components having a small density difference, which are hardly separable, is frequent, so that it is possible to conduct the separation in a higher separation precision and a higher recovery ratio by making the density distribution of the middle floating component as narrower as possible to render the value u₀/u_{mf} into either levitating or sinking of such a component.

For example, the u₀/u_{mf} value can be made within a range of 1-4, because the stable gas-solid fluidized bed can be formed at this range. However, the u₀/u_{mf} value is not limited to such a range, but it may be more than 4 when the components having a large density difference are rapidly separated.

In case of fluidizing single powder, if it is intended to separate the components having a small density difference therebetween, the u₀/u_{mf} value is preferable to be near to 1 as far as possible though it depends on the powder used. The u₀/u_{mf} value may be 1-1.5, preferably 1-1.2, and more preferably 1-1.1.

In case of fluidizing plural kinds of powders, the air blowing is preferable to be carried out under a value of the ratio u₀/u_{mf} so as to uniformly mix the plural powders. If the plural powders are not uniformly mixed, the bulk density becomes small upward of the gas-solid fluidized bed, while the bulk density becomes large downward of the gas-solid fluidized bed, so that the density distribution of the component located at the middle part of the gas-solid fluidized bed tends to become large.

The kind of the powder is not particularly limited according to the kind of the object to be separated, but may be at least one selected from the group consisting of unibeads®, glass beads, zirconsands, polystyrene particles and steel shots.

An average particle size of the powder used is not particularly limited, but it is preferable to be 100-500 μm from viewpoints that the fluidization of the powder is carried out at a relatively small superficial velocity and the aggregation of the powder is suppressed.

Each of the components separated from the object to be separated as mentioned above is levitated or sunk and may be finally recovered by a proper way.

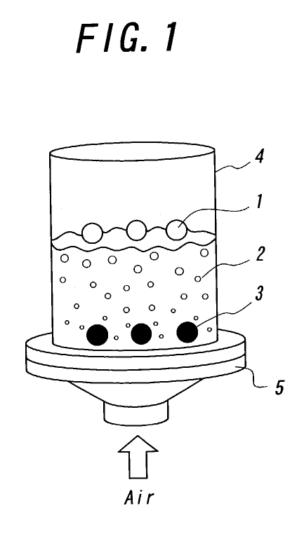

An embodiment of the dry separation apparatus according to the invention will be described with reference to the accompanying drawings below. FIG. 1 is a view illustrating float-sink states of materials in a gas-solid fluidized bed, in which 1 is a component lighter than a bulk density of a fluidized bed, 2 a gas-solid fluidized bed, 3 a component heavier than the bulk density of the fluidized bed, 4 a separation tank, and 5 a gas-dispersing plate. As seen from this figure, the materials can be separated by the bulk density of the gas-solid fluidized bed at a fluidized state of powder.

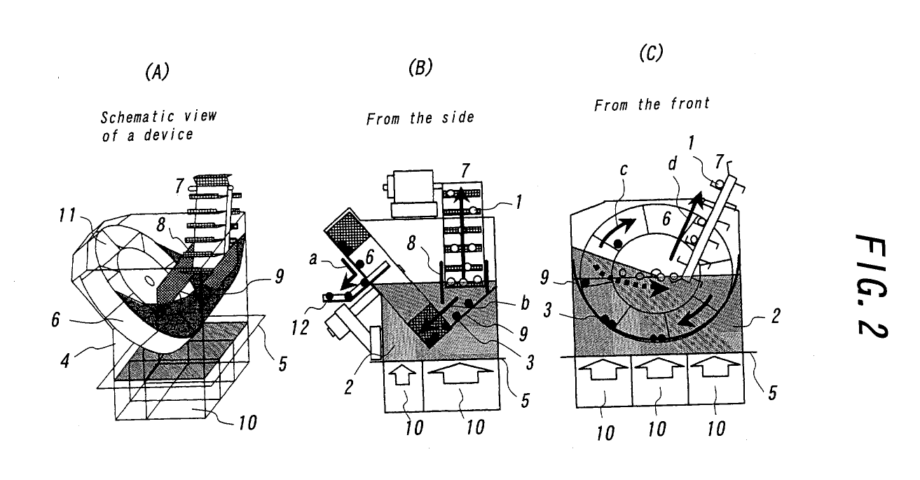

An example of the procedure for the separation is explained. At first, the fluidizing medium such as glass beads, unibeads®, zirconsands, polystyrene particles or the like is charged into the separation tank 4, and a gas is uniformly fed from a bottom face of the separation tank 4 through the gas-dispersing plate 5 into the inside of the separation tank 4 to fluidize the medium or powder, whereby the fluidized bed 2 is formed. When an object to be separated is charged in the separation tank 4 from its upper opening, a component to be separated having a density heavier than the powder used sinks. FIG. 2 shows an example of the apparatus for recovering components separated from the object to be separated. FIG. 2(A) is an outline of the apparatus, and FIG. 2(B) is a side view of the apparatus, and FIG. 2(C) is a front view of the apparatus.

In FIG. 2(A), 6 is a collecting means, 7 a transport means, 8 a protection plate, 9 a guide plate, and 10 a gas chamber. The collecting means 6 rotatably moves at a slower speed in a direction shown by an arrow c in FIG. 2(C), during which a heavy component 3 sunk from the object to be separated is recovered and discharged to the outside of the separation tank 4. That is, the heavy component 3 in the object to be separated is guided into the collecting means 6 through the guide plate 9 and collected in baskets 11 disposed in the collecting means 6. The heavy component 3 in the basket 11 is moved toward the upper part of the separation tank through the rotation of the collecting means, at where it is moved to a discharge port 12 through its own weight.

On the other hand, the transport means 7 is moved in a direction shown by an arrow d in FIG. 2(C) while rotating at a slow speed, during which a light component 1 levitating in the object to be separated is recovered and discharged toward the outside of the separation tank 4. In this case, the protection plate 8 easily guides the light component 1 from the object to be separated into the transport means. Although the light component 1 can be recovered without arranging the protection plate 8, it is desirable to arrange the protection plate 8 for efficiently recovering the light component 1 at a high recovering ratio. The thus guided light component 1 is discharged to the outside of the separation tank 4 by means of the transport means 7 such as a conveyor or the like.

In FIG. 2, numeral 5 is a gas-dispersing plate, which is made of a porous material such as a wire netting or the like. In this case, the wire netting is required to have a fine mesh not passing the object to be separated. Furthermore, the gas for making the fluidized bed is not limited to air, but may include other gases.

Each of the protection plate and the guide plate is not limited to the embodiment shown in FIG. 2, but may be properly modified unless they have such a function that the light component or the heavy component can easily be guided to the transport means or the collecting means. For example, plural pierced plates may be arranged so as to prevent mixing of the levitating component and the sinking component on the way of the recovery. Furthermore, a propeller for the levitating component may be arranged instead of the protection plate, while a propeller may be arranged on the bottom of the gas-solid fluidized bed instead of the transport means to efficiently guide the sinking component to the collecting means.

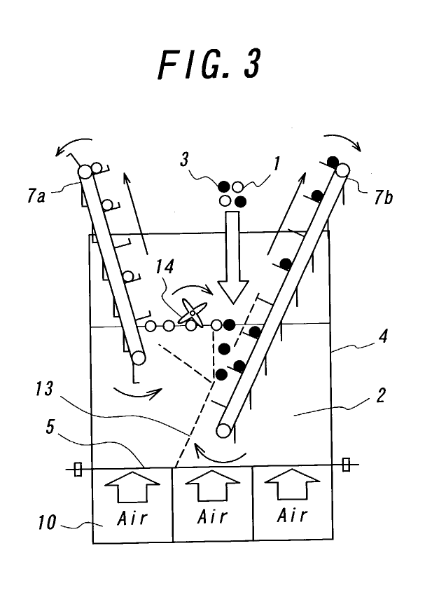

Another example of the recovering method is shown in FIG. 3, which shows an apparatus for recovering components separated from a shredder dust. In FIG. 3, a transport means 7b is moved in a direction of an arrow while rotating at a slow speed, during which a heavy component sinking from the shredder dust is recovered and discharged to the outside of the separation tank 4.

On the other hand, a transport means 7a is moved in a direction of an arrow while rotating at a slow speed, during which a light component levitating from the shredder dust is recovered and discharged to the outside of the separation tank 4.

Moreover, numeral 13 in FIG. 3 is a porous plate, which is made of a porous material such as a wire netting or the like. In this case, the wire netting is required to have a fine mesh not passing the object to be separated. The gas-dispersing plate is also the same. Moreover, the gas for making the fluidized bed is not limited to air, but may include other gases.

If the porous plate 13 is possible to guide the levitating component and the sinking component to separate transport means such as conveyors and the like, it is not limited to the construction shown in FIG. 3, but may be properly modified. For example, plural pierced plates may be arranged so as to prevent mixing of the levitating component and the sinking component on the way of the recovery. Furthermore, a propeller 14 or the levitating component is arranged in FIG. 3. Also, a propeller may be arranged on the bottom of the gas-solid fluidized bed to efficiently guide the sinking component to the conveyor.

The following examples are given in illustration of the invention and are not intended as limitations thereof.

### EXAMPLE 1

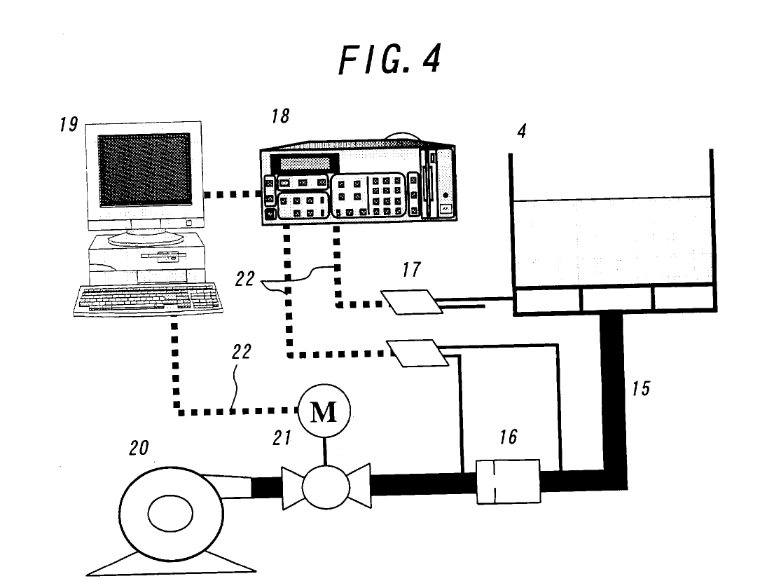

First of all, a separation system as shown in FIG. 4 is used for examining a relationship between a mixing ratio and a bulk density of mixed powders. At a bottom of a separation tank is arranged an air-dispersing plate constructed by sandwiching a cloth between two porous stainless steel plates each having a hole diameter of 0.2 cm, a pitch of 0.3 cm and an opening ratio of 40.3%. A powder is charged in the separation tank so as to have a height of 40 cm and fluidized by feeding air through a blower, in which a superficial velocity is fine adjusted by opening and closing a motor valve. Since a large tank (a side of 60 cm×a depth of 45 cm×a height of powder of 40 cm) is used as the separation tank, a sectional area of an air chamber beneath the gas-dispersing plate is increased, so that the air chamber is divided into 6 parts, whereby a superficial velocity in each part is controlled at a high precision.

In FIG. 4, numeral 4 is a separation tank, 15 a gas, 16 an orifice meter, 17 a pressure sensor, 18 a data logger, 19 a personal computer, 20 a blower, 21 a motor valve, and 22 an electrical signal.

A pressure of the orifice meter 16 and a pressure difference between the bottom of the fluidized bed and an atmosphere are read as a voltage value by means of the pressure sensor 17 to measure a superficial velocity u₀ and a pressure loss ΔP using previously obtained relational expressions of voltage-superficial velocity and voltage-pressure loss. The term “pressure loss ΔP” used herein means a pressure applied from the powder to the gas in the fluidization of the powder by the gas. For example, when the gas is fed from the bottom, a pressure corresponding to the weight of the powder is applied to the gas, which is called as a pressure loss ΔP. As the superficial velocity exceeds a certain value, the fluidization of the powder is started and the pressure loss become constant. In other words, the case that the pressure loss is constant indicates the fluidized state of the powder.

In the process of gradually decreasing u₀, ΔP is measured, during which a value of u₀ when ΔP begins to decrease from the constant value is determined as a minimum fluidization velocity u_{mf}.

Actually, an experiment is carried out by charging two powders of steel shots (S.S.) and glass beads (G.B.) mixed at various bulk volume fractions V_{s.s.} in the tank so as to have a height of about 40 cm and fluidizing them so as to be a relationship u₀/u_{mf} between the superficial velocity u₀ and the minimum fluidization velocity u_{mf} of 1.7. Also, an air permeability is set to 0.3 (cm³/s)/cm². Moreover, the minimum fluidization velocity is calculated by a relationship of superficial velocity-pressure loss obtained in the process of decreasing u₀ from such a value u₀ that the two powders are completely mixed so as not to cause segregation. The properties of the powders used are shown in Table 1.

TABLE 1

| | size | true density | bulk density |
|---|---|---|---|
| Powder | (μm) | (kg/m³) | (kg/m³) |
| steel shots | 45-106 | 7600 | 4300 |
| glass beads | 180-250 | 2500 | 1500 |

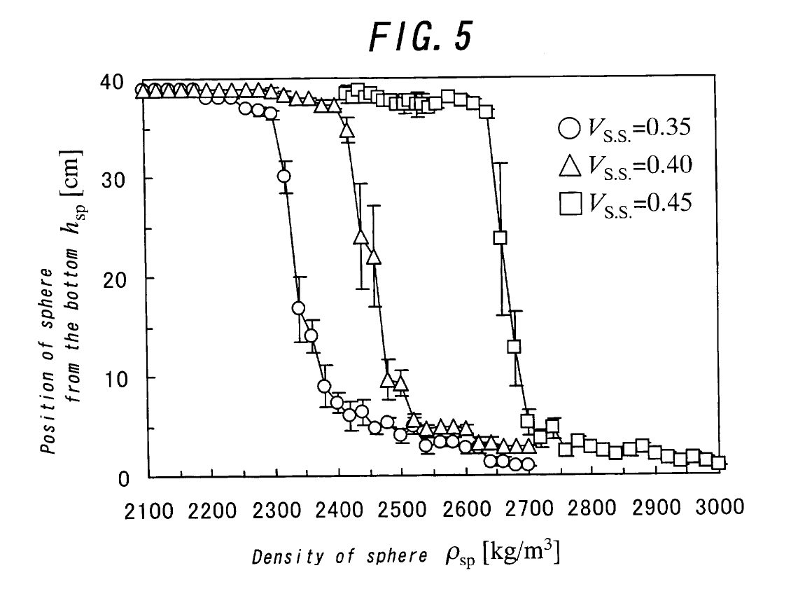

The experimental results are shown in FIG. 5. In FIG. 5 is shown a float-sink state of each of spheres having given densities on a gas-dispersing plate having a low air permeability (0.3 (cm³/s)/cm²) in the tank. It shows a tendency that lighter spheres sink as the amount of the steel shots is less (0.35), while heavier spheres sink as the amount of the steel shots is large (0.45). Since a density of the spheres at a float-sink boundary represents a bulk density of the fluidized bed, as the ratio of the steel shots having a density heavier than that of the glass beads becomes large, the bulk density increases. As regards the mixing ratio of the powders, V_{s.s.}=0.35 is S.S.:G.B.=35:65, and V_{s.s.}=0.40 is S.S.:G.B.=40:60, and V_{s.s.}=0.45 is S.S.:G.B.=45:55.

As seen from the results of FIG. 5, the bulk density increases as the ratio of the heavy powder in the mixed powders increases.

### EXAMPLE 2

Next, a separation test using mineral ores, particularly silicastone and pyrophyllite as an object to be separated is carried out by using the same systems as described in Example 1. The silicastone has a peak at 2300-2550 kg/m ³, while the pyrophyllite is distributed in a narrow range of 2650-2750 kg/m³ having a peak at 2700 kg/m³. They have an equivalent volume diameter within a range of 10-50 mm, in which the silicastone is 30.5±8.6 mm, and pyrophyllite is 30.3±8.1 mm.

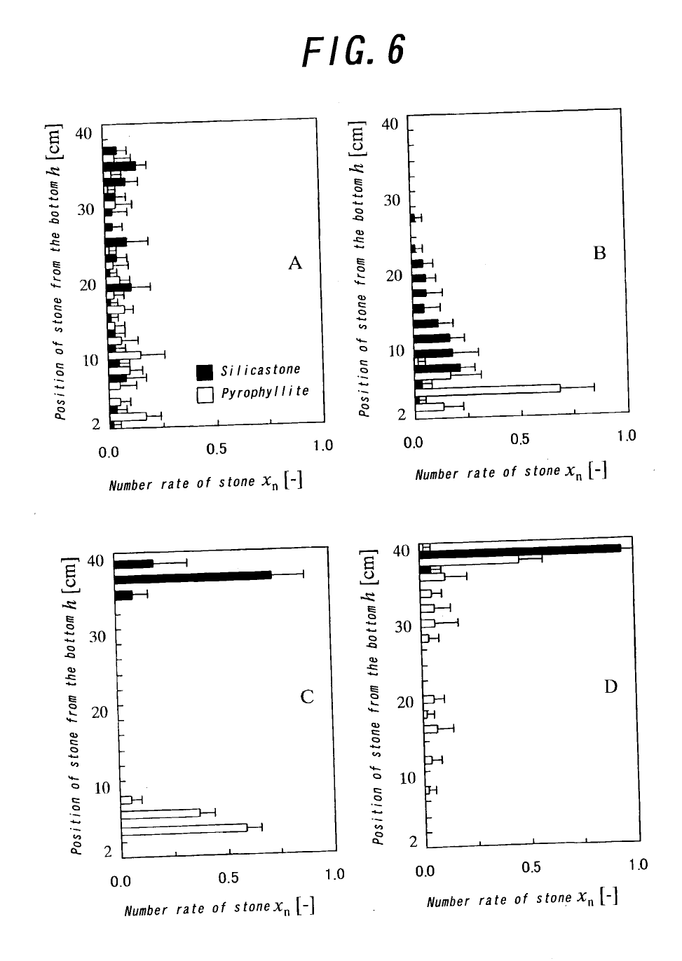

FIG. 6 shows float-sink of the silicastone and the pyrophyllite under various conditions in the bed. FIG. 6A is a case that conditions are an air permeability=8.13 (cm³/s)/cm² and V_{s.s.}=0.40, and FIG. 6B is a case that the conditions are an air permeability=0.30 (cm³/s)/cm² and V_{s.s.}=0.35, and FIG. 6C is a case that the conditions are an air permeability=0.30(cm³/s)/cm² and V_{s.s.}=0.40, and FIG. 6D is a case that the conditions are an air permeability=0.30(cm³/s)/cm² and V_{s.s.}=0.45.

As the ore used in the experiment, a stone having a certain average density is picked up from the silicastone and the pyrophyllite, respectively. Such a stone is charged onto each of the six gas chambers in the tank, and a height in the tank is measured after one minute of the charging, and such a procedure is repeated 10 times. From the thus obtained results is plotted the number ratio of the stones existing in each height. In case of the gas-dispersing plate having a high air permeability, both the mineral ores are existent at an approximately equal ratio in each of the heights and the stable float-sink is not obtained. On the other hand, in case of V_{s.s.}=0.35, both the mineral ores sink because the bulk density of the fluidized bed is too small, while in case of V_{s.s.}=0.45, both the mineral ores levitate because the bulk density is too large. In case of V_{s.s}=0.40, both the mineral ores are substantially completely separated because the silicastone levitates and the pyrophyllite sinks.

As seen from the above result, when the air permeability is low as compared with the case of 8.13(cm³/S)/cm², the float-sink is considerably stable and the separation can be conducted more aqurately.

### EXAMPLE 3

Next, the separation of objective components is tried while continuously removing impurities. As a separation tank is prepared an acrylic cylinder having an inner diameter of 25.4 cm, a height of 52 cm and a thickness of 0.5 cm. A gas-dispersing plate constructed by sandwiching a cloth between two porous stainless steel plates each having a hole diameter of 0.2 cm, a pitch of 0.3 cm and an opening ratio of 40.3% is arranged on a bottom of the tank. The test is carried out in the same manner as in Example 1 except that the air permeability is adjusted to 0.3(cm³/s)/cm² and the powder is charged in the tank so as to have a height of 10 cm.

As the objective component to be separated are used silicastone and pyrophyllite. As the impurity are used a wood chip, a coal, an engineering plastic and an iron scrap.

As the powder are used glass beads (particle size: 180-250 μm) and steel shots (particle size: 45-106 μm).

At first, only glass beads are placed up to a height of 10 cm in the tank and fluidized under three type conditions of u₀/u_{mf}=1.1, 1.5 and 2.0. The experiment procedure and results are as follows. In case of only the glass beads, six kinds of objective materials to be separated are charged into the tank one by one, and their heights in the tank are measured after 1 minute of the charging every each condition.

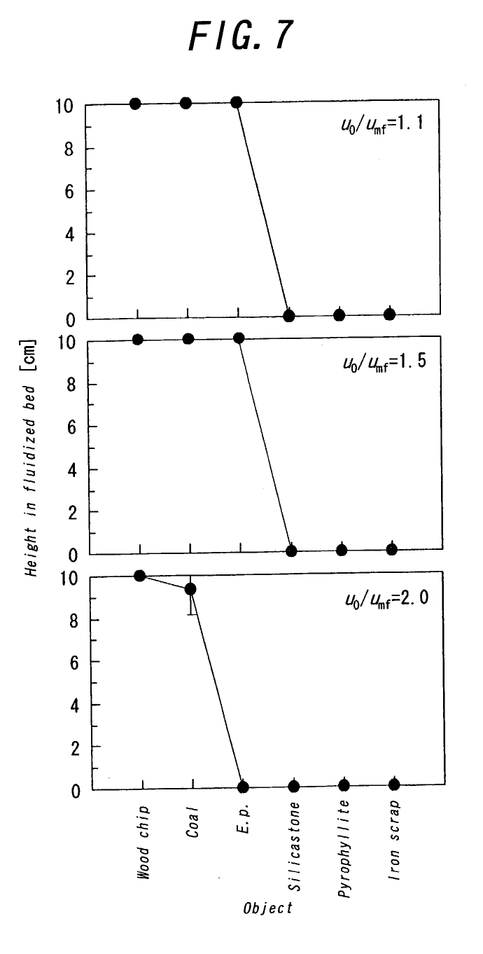

The results are shown in FIG. 7. As shown in FIG. 7, the wood chip, coal and engineering plastic levitate and the others sink at u₀/u_{mf}=1.1 and 1.5.

At u₀/u_{mf}=2.0, the engineering plastic also sinks because the bulk density of the fluidized bed becomes small according to the increase of the blowing velocity. From the these results, it is understood that the wood chip, coal and engineering plastic can be separated from the six kinds of the objective materials at u₀/u_{mf}=1.1 and 1.5.

Actually, the wood chip, coal and engineering plastic as an impurity are continuously separated and removed by changing the u₀/u_{mf} value with the use of the separation apparatus of FIG. 2. Moreover, the silicastone, pyrophyllite and iron scrap as a sediment are removed out from the separation tank by using the separation apparatus of FIG. 2 once.

Next, the removal of the iron scrap as a further impurity is tried by charging only steel shots into the tank up to a height of 10 cm and fluidizing under three type conditions of u₀/u_{mf}=1.1, 1.5 and 2.0.

The sunk silicastone, pyrophyllite and iron scrap are charged into the fluidized bed, and their heights in the bed are measured after 1 minute of the charging every each condition.

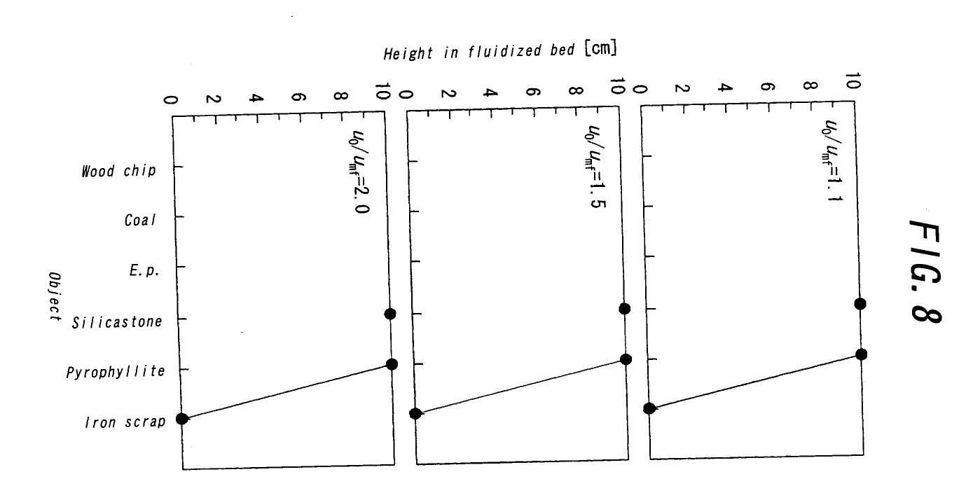

The results are shown in FIG. 8. As seen from FIG. 8, only the iron scrap is sunk in any u₀/u_{mf} values. The sunk steel scrap is separated and recovered by the separation apparatus. The levitating silicastone and pyrophyllite are also recovered in the same manner, and guided to a next separation tank.

Finally, the separation between silicastone and pyrophyllite is tried. The levitating silicastone and pyrophyllite are charged into the fluidized bed using mixed powders of glass beads and steel shots, and their heights in the bed are measured after 1 minute of the charging every each condition mentioned below. Concretely, the glass beads and steel shots are mixed at a volume ratio of 60:40 and charged so as to have a height of 10 cm, and then fluidized under three type conditions of u₀/u_{mf}=1.1, 2.0 and 3.0.

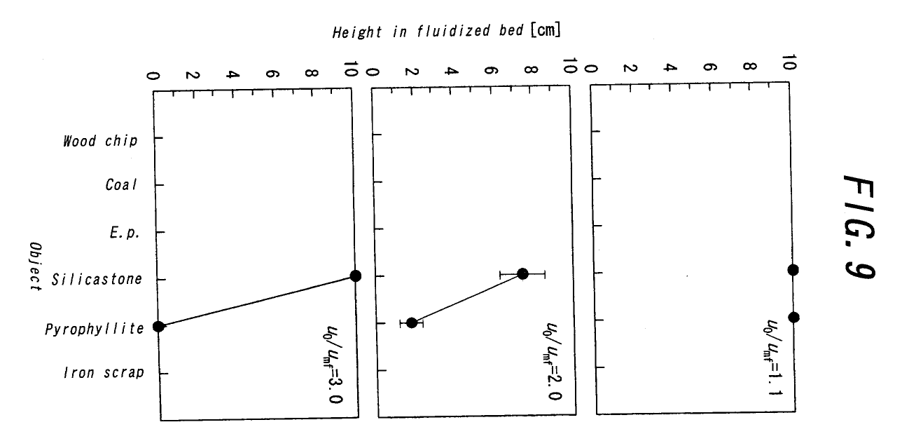

The results are shown in FIG. 9. As shown in FIG. 9, in the case of u₀/u_{mf}=3.0, the silicastone levitates and the pyrophyllite sinks. On the other hand, the reason why the same result is not obtained under the other u₀/u_{mf} values is considered due to the fact that as the u₀/u_{mf} becomes small, the glass beads are not well mixed with the steel shots, or the fluidization is too moderate.

The levitating silicastone and sinking pyrophyllite are recovered in the same manner as described above using the apparatus shown in FIG. 2, respectively.

By continuously using three kinds of the fluidized beds as mentioned above, the impurities such as wood chip, coal, engineering plastic and iron scrap can be removed from the six objective materials, and then both the silicastone and the pyrophyllite can be separated.

The invention develops advantageous effects that the apparatus cost is low, and an efficiency is high, and the dry step after the treatment of waste liquid or the separation is useless, and the influence upon the environment is hardly caused.

Also, the invention can be available in the area of the low water resource owing to the dry separation.

In the apparatus according to the invention, the sunk material can be discharged by rotating a rotor in the separation tank, so that the continuous separation selection can be automatically carried out by a simple mechanism.

What is claimed is:

1. A dry separation method which comprises charging an object to be separated into a gas-solid fluidized bed fluidizing powder and continuously separating the object to be separated into components through the utilization of a bulk density of the gas-solid fluidized bed.

2. A dry separation method according to claim 1, wherein the continuous separation is carried out by changing the bulk density.

3. A dry separation method according to claim 1 or 2, wherein the fluidization of powder is carried out by blowing air into a lower part of the gas-solid fluidized bed.

4. A dry separation method according to claim 3, wherein the air blowing is carried out under a condition that an air permeability is not more than 5.0 (cm³/s)/cm².

5. A dry separation method according to any one of claims 1 to 4, wherein the air blowing is carried out at a ratio u₀/u_{mf} of 1-4 wherein u₀ is a superficial velocity and u_{mf} is a minimum fluidization velocity of the powder.

6. A dry separation method according to claim 5, wherein when plural powders are fluidized, the air blowing is carried out under a value of the ratio u₀/u_{mf} so as to uniformly mix the plural powders.

7. A dry separation method according to any one of claims 1 to 6, wherein the bulk density of the gas-solid fluidized bed is set to be between maximum density and minimum density of components in the object to be separated.

8. A dry separation method according to any one of claims 1 to 6, wherein the powder is at least one selected from the group consisting of unibeads®, glass beads, zirconsands, polystyrene particles, steel shots and powders having a density nearly equal thereto.

9. A dry separation method according to any one of claims 1 to 8, wherein the object to be separated is a mineral ore and contains an impurity(s).

10. A dry separation method according to claim 9, wherein the mineral ore is silicastone and pyrophyllite.

11. A dry separation method according to any one of claims 1 to 10, wherein the powder has an average particle diameter of 100-500 μm.

12. A dry separation apparatus comprising a separation tank including therein a gas-solid fluidized bed fluidizing powder and provided on its bottom face with a porous dispersing plate(s), and plural transport means, at least a part of which being got into the gas-solid fluidized bed.

13. A dry separation apparatus according to claim 12, wherein at least one of the plural transport means transports sediment sunk in the gas-solid fluidized bed and discharges them from the separation bath to an outside thereof.

14. A dry separation apparatus according to claim 12, wherein at least one of the plural transport means transports floats levitated in the gas-solid fluidized bed and discharges them from the separation bath to an outside thereof.

15. A dry separation apparatus according to claim 13, wherein the transport means is a rotatable collecting means set in an inclined position.
